(19) United States
(12) Patent Application Publication
(10) Pub. No.: US 2025/0376023 A1
(43) Pub. Date: Dec. 11, 2025

(54) VEHICLE GENERATOR MODULE WITH TRANSMISSION

(71) Applicant: Schaeffler Technologies AG & Co. KG, Herzogenaurach (DE)

(72) Inventor: Matthew Payne, Glenmont, OH (US)

(73) Assignee: Schaeffler Technologies AG & Co. KG, Herzogenaurach (DE)

(21) Appl. No.: 19/068,014

(22) Filed: Mar. 3, 2025

Related U.S. Application Data
(60) Provisional application No. 63/656,418, filed on Jun. 5, 2024.

(51) Int. Cl. B60K 17/356; B60K 6/24; B60K 6/26; B60K 6/28; B60K 6/36; B60K 17/354

(52) U.S. Cl. CPC B60K 17/356; B60K 6/24; B60K 6/26; B60K 6/28; B60K 6/36; B60K 17/354; B60Y 2200/92

(57) ABSTRACT

A vehicle includes a combustion engine, a first axle assembly rotationally connected to a first pair of driving wheels, and a vehicle generator module. The vehicle generator module includes a rotor rotationally connected to the combustion engine, a stator circumscribing the rotor and arranged for generating an electrical power when the rotor is rotated by the combustion engine, and a clutch for selectively rotationally connecting the combustion engine to the first axle assembly. In some example embodiment, the vehicle also includes a transmission arranged in a torque path between the clutch and the first axle assembly. In an example embodiment, the transmission is a single speed transmission.

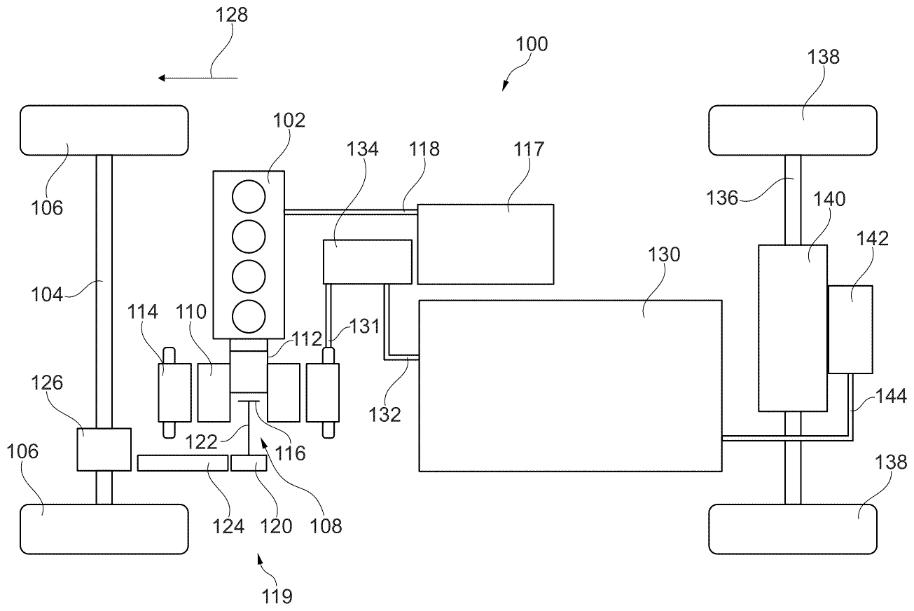

### CROSS-REFERENCE TO RELATED APPLICATIONS

This application claims the benefit of U.S. Provisional Patent Application No. 63/656,418, filed Jun. 5, 2024, the disclosure of which is incorporated in its entirety by reference herein.

### TECHNICAL FIELD

The present disclosure relates generally to a vehicle generator module, and more specifically to a vehicle generator module with a transmission.

### BACKGROUND

Vehicle driving assemblies are known. One example is shown and described in U.S. Pat. No. 10,844,934 titled VEHICLE DRIVING ASSEMBLY WITH TRANSVERSELY PLACED DOUBLE POWER SOURCES to Yu et al.

### SUMMARY

Example embodiments broadly comprise a vehicle including a combustion engine, a first axle assembly rotationally connected to a first pair of driving wheels, and a vehicle generator module. The vehicle generator module includes a rotor rotationally connected to the combustion engine, a stator circumscribing the rotor and arranged for generating an electrical power when the rotor is rotated by the combustion engine, and a clutch for selectively rotationally connecting the combustion engine to the first axle assembly. In some example embodiment, the vehicle also includes a transmission arranged in a torque path between the clutch and the first axle assembly. In an example embodiment, the transmission is a single speed transmission.

In an example embodiment, the combustion engine is arranged transverse to a driving direction of the vehicle. In an example embodiment, the first axle assembly is arranged at a front of the vehicle. In some example embodiments, the vehicle also includes a battery for receiving the electrical power from the stator. In an example embodiment, the vehicle includes a converter for converting an alternating current from the stator into a direct current for the battery.

In some example embodiments, the vehicle also includes a second axle assembly rotationally connected to a second pair of driving wheels, and an electric motor arranged for propelling the vehicle via the second axle assembly. In an example embodiment, the second axle assembly is arranged at a rear of the vehicle. In some example embodiments, the vehicle also includes a battery for receiving the electrical power from the stator, and the electric motor is electrically connected to the battery. In an example embodiment, the vehicle also includes an inverter for inverting a direct current from the battery into an alternating current for the electric motor.

Other example aspects broadly comprise a vehicle including a combustion engine, a first axle assembly rotationally connected to a first pair of driving wheels, a vehicle generator module, a second axle assembly, an electric motor and a battery. The vehicle generator module includes a rotor rotationally connected to the combustion engine, a stator circumscribing the rotor and arranged for generating an electrical power when the rotor is rotated by the combustion engine, and a clutch for selectively rotationally connecting the combustion engine to the first axle assembly. The second axle assembly is rotationally connected to a second pair of driving wheels, the electric motor is arranged for propelling the vehicle via the second axle assembly, and the battery is for receiving the electrical power from the stator and providing the electrical power to the electric motor. In some example embodiments, the vehicle also includes a transmission arranged in a torque path between the clutch and the first axle assembly. In an example embodiment, the transmission is a single speed transmission.

In an example embodiment, the combustion engine is arranged transverse to a driving direction of the vehicle. In some example embodiments, the first axle assembly is arranged at a front of the vehicle, and the second axle assembly is arranged at a rear of the vehicle. In an example embodiment, the vehicle also includes a converter for converting an alternating current from the stator into a direct current for the battery, and an inverter for inverting a direct current from the battery into an alternating current for the electric motor.

A method of operating the vehicle is also disclosed. The method includes propelling the vehicle with the electric motor via the second axle assembly, and engaging the clutch to rotationally connect the combustion engine to the first axle assembly to provide additional propulsion when the battery is depleted or additional traction is required.

### BRIEF DESCRIPTION OF THE DRAWINGS

The single figure illustrates a schematic view of a vehicle propulsion arrangement according to an example embodiment.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

The single figure illustrates a schematic view of a vehicle propulsion arrangement according to an example embodiment. Vehicle 100 includes combustion engine 102, axle assembly 104 rotationally connected to driving wheels 106 and vehicle generator module 108. The generator module includes rotor 110 rotationally connected to the combustion engine via shaft 112, for example, stator 114 circumscribing the rotor and arranged for generating an electrical power when the rotor is rotated by the combustion engine, and clutch 116 for selectively rotationally connecting the combustion engine to the first axle assembly as described in more detail below. Fuel from combustion engine 102 is provided by fuel tank 117 through fuel line 118. Although not shown, some embodiments may include a damper on shaft 112 to isolate combustion engine vibrations from the rotor.

The clutch operates to rotationally connect and disconnect the combustion engine from the axle assembly, but rotor 110 always remains connected to the engine. Clutch 116 may be a normally closed clutch in which an external operator (not shown) is required to disengage the engine from the axle assembly, or a normally open clutch in which an operator (not shown) is required to engage the engine with the axle assembly. The clutch operator may be a hydraulic piston, an electrohydraulic device, or an electric actuator, for example. Some embodiments may include a mechanical clutch operator manually engaged by a vehicle driver, for example.

Vehicle 100 also includes transmission 119 arranged in a torque path between the clutch and axle assembly 104. In the embodiment shown, transmission 119 is a single speed transmission. That is, the transmission includes pinion gear 120 driven by shaft 122, connected to the clutch, and spur gear 124 connecting the pinion gear to differential 126 of axle assembly 104. Although transmission 119 is shown as a pinion-spur transmission, other arrangements are possible. For example, other embodiments (not shown) may include transmission 119 as a planetary gear transmission with a chain or belt drive to the differential. The generator module, transmission and differential may be enclosed within a common housing (not shown).

As shown in the single figure, the combustion engine is arranged transverse to driving direction 128 of the vehicle and axle assembly 104 is arranged at a front of the vehicle, similar to the arrangement found in non-hybrid front-wheel-drive (FWD) vehicles. Other embodiments (not shown) may include the combustion engine and axle assembly 104 mounted at a rear of the vehicle as is common in some sports cars, for example.

Vehicle 100 also includes battery 130 for receiving the electrical power from the stator via electrical connections 131 and 132, and converter 134 for converting an alternating current (AC) from the stator into a direct current (DC) for the battery. That is, due to configuration of the generator module, the alternating current output cannot be stored directly into the batter because the battery only stores direct current. Hence, the converter is arranged in the power flow between the stator and the battery to convert the electrical power into a form that can be accepted by the battery.

Vehicle 100 also includes axle assembly 136 rotationally connected to driving wheels 138, and electric motor 140 arranged for propelling the vehicle via axle assembly 136. Electric motor 140 may be coaxial to axle assembly 136 and drivingly connected to the axle assembly via a planetary transmission, or radially offset from the axle assembly and drivingly connected via a pinion-spur gear arrangement similar to transmission 119 described above. In the embodiment shown, axle assembly 136 is arranged at a rear of vehicle 100 although axle assembly 136 may be arranged at a front of the vehicle in other embodiments (not shown) where axle assembly 104 is a rear axle, for example.

Motor 140 is electrically connected to battery 130 through inverter 142 and electrical connection 144. Opposite to converter 134 described above, inverter 142 inverts a direct current from the battery into an alternating current for the electric motor. That is, the electric motor may be an AC (e.g., three-phase) induction motor that generally operates more efficiently than a DC motor and the inverter provides the electrical power in a form that the motor can accept. The inverter may also include circuitry to adjust the electrical power to control vehicle speed, for example. Thus, there is no mechanical connection between front and rear tires and only an electrical connection between front and rear drive systems. Thus, vehicle 100 includes exactly one combustion engine, exactly one generator module and converter, and exactly one electric motor and inverter, while still providing power to both axles when required.

Operation of vehicle 100 will now be described. During normal operation of vehicle 100, the vehicle may be propelled by electric motor 140 via axle assembly 136. Power from battery 130 provides DC current that is inverted to AC current by inverter 142. Combustion engine 102 may be operated to rotate rotor 110 in stator 114 to provide additional power to the battery via converter 134. Under a high battery power demand (e.g., towing a trailer up an incline) or if the battery is depleted to a point where power from the generator module is insufficient to propel the vehicle through motor 140 due to sizing of the generator module and/or conversion losses through the converter and inverter, for example, clutch 116 may be engaged to rotationally connect the combustion engine to axle assembly 104 to provide additional propulsion. Clutch 116 may also be engaged in certain operating conditions when additional traction is required to provide an all-wheel-drive (AWD) or a four-wheel-drive (4WD) mode, for example, or to provide a fail-safe, limp-home mode to get the vehicle to a charging station or to a repair facility due to failure of the electric motor or axle assembly 136, for example.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Vehicle
102 Combustion engine
104 Axle assembly (first)
106 Driving wheels (first)
108 Vehicle generator module
110 Rotor
112 Shaft (rotor to combustion engine)
114 Stator
116 Clutch (combustion engine to first axle assembly)
117 Fuel tank
118 Fuel line
119 Transmission
120 Pinion gear (transmission)
122 Shaft (clutch to pinion gear)
124 Spur gear (transmission)
126 Differential (first axle assembly)
128 Driving direction
130 Battery
131 Electrical connection (stator to converter)
132 Electrical connection (converter to battery)
134 Converter
136 Axle assembly (second)
138 Driving wheels (second)
140 Electric motor
142 Inverter
144 Electrical connection (inverter to battery)

What is claimed is:

1. A vehicle, comprising:
a combustion engine;
a first axle assembly rotationally connected to a first pair of driving wheels; and
a vehicle generator module comprising:
a rotor rotationally connected to the combustion engine;
a stator circumscribing the rotor and arranged for generating an electrical power when the rotor is rotated by the combustion engine; and
a clutch for selectively rotationally connecting the combustion engine to the first axle assembly.

2. The vehicle of claim 1 further comprising a transmission arranged in a torque path between the clutch and the first axle assembly.

3. The vehicle of claim 2 wherein the transmission is a single speed transmission.

4. The vehicle of claim 1 wherein the combustion engine is arranged transverse to a driving direction of the vehicle.

5. The vehicle of claim 1 wherein the first axle assembly is arranged at a front of the vehicle.

6. The vehicle of claim 1 further comprising a battery for receiving the electrical power from the stator.

7. The vehicle of claim 6 further comprising a converter for converting an alternating current from the stator into a direct current for the battery.

8. The vehicle of claim 1 further comprising:
a second axle assembly rotationally connected to a second pair of driving wheels; and
an electric motor arranged for propelling the vehicle via the second axle assembly.

9. The vehicle of claim 8 wherein the second axle assembly is arranged at a rear of the vehicle.

10. The vehicle of claim 8 further comprising a battery for receiving the electrical power from the stator, wherein the electric motor is electrically connected to the battery.

11. The vehicle of claim 10 further comprising an inverter for inverting a direct current from the battery into an alternating current for the electric motor.

12. A vehicle comprising a combustion engine;
a first axle assembly rotationally connected to a first pair of driving wheels;
a vehicle generator module comprising:
a rotor rotationally connected to the combustion engine;
a stator circumscribing the rotor and arranged for generating an electrical power when the rotor is rotated by the combustion engine; and
a clutch for selectively rotationally connecting the combustion engine to the first axle assembly;
a second axle assembly rotationally connected to a second pair of driving wheels;
an electric motor arranged for propelling the vehicle via the second axle assembly; and
a battery for receiving the electrical power from the stator and providing the electrical power to the electric motor.

13. The vehicle of claim 12 further comprising a transmission arranged in a torque path between the clutch and the first axle assembly.

14. The vehicle of claim 13 wherein the transmission is a single speed transmission.

15. The vehicle of claim 12 wherein the combustion engine is arranged transverse to a driving direction of the vehicle.

16. The vehicle of claim 12 wherein:
the first axle assembly is arranged at a front of the vehicle; and
the second axle assembly is arranged at a rear of the vehicle.

17. The vehicle of claim 16 further comprising:
a converter for converting an alternating current from the stator into a direct current for the battery; and
an inverter for inverting a direct current from the battery into an alternating current for the electric motor.

18. A method of operating the vehicle of claim 12 comprising:
propelling the vehicle with the electric motor via the second axle assembly; and
engaging the clutch to rotationally connect the combustion engine to the first axle assembly to provide additional propulsion when the battery is depleted or additional traction is required.
